(19) United States
(12) Patent Application Publication
(10) Pub. No.: US 2026/0304040 A1
(43) Pub. Date: Oct. 1, 2026

(54) MULTI-MONITOR SOUND MAPPING SYSTEM

(71) Applicant: Lenovo (United States) Inc., Morrisville, NC (US)

(72) Inventors: Nathan Peterson, Oxford, NC (US); Mark Delaney, Raleigh, NC (US); John C. Mese, Cary, NC (US); Robert J. Kapinos, Durham, NC (US); Diana Gerli, Raleigh, NC (US)

(21) Appl. No.: 19/094,108

(22) Filed: Mar. 28, 2025

(51) Int. Cl. H04R 3/12; G06F 3/16

(52) U.S. Cl. CPC H04R 3/12; G06F 3/167

(57) ABSTRACT

One embodiment provides a method, the method including: receiving, at a sound mapping system, an indication to output a sound at one of a plurality of audio output devices; determining, utilizing the sound mapping system, at least one audio output device of the plurality of audio output device to output the sound, wherein the determining comprises identifying a component corresponding to the sound and associating the component with the at least one audio output device; and outputting, utilizing the sound mapping system, the sound from the at least one audio output device. Other aspects are claimed and described.

### BACKGROUND

Computer workstations are growing in size with each day. A common workstation practice now is to have two or more monitors that provide more area to display information. This increase in display area permits a user to move back-and-forth between applications, information, and/or the like, with ease. An increase in workstation size is also not limited to professional use. Recreational workstations are also increasing in size in a similar manner, for example, two or more monitors, processing power, graphic cards, and/or the like, to increase a user experience. As workstations transition from a single-monitor system to a multi-monitor system, traditional peripheral devices must also transition in order to provide the highest quality experience to a user.

### BRIEF SUMMARY

In summary, one aspect provides a method, the method including: receiving, at a sound mapping system, an indication to output a sound at one of a plurality of audio output devices; determining, utilizing the sound mapping system, at least one audio output device of the plurality of audio output device to output the sound, wherein the determining comprises identifying a component corresponding to the sound and associating the component with the at least one audio output device; and outputting, utilizing the sound mapping system, the sound from the at least one audio output device.

Another aspect provides a device, the device including: a processor; a memory device that stores instructions that, when executed by the processor, causes the system to: receive, at a sound mapping system, an indication to output a sound at one of a plurality of audio output devices; determine, utilizing the sound mapping system, at least one audio output device of the plurality of audio output device to output the sound, wherein the determining comprises identifying a component corresponding to the sound and associating the component with the at least one audio output device; and output, utilizing the sound mapping system, the sound from the at least one audio output device.

A further aspect provides a product, the product including: a computer-readable storage device that stores executable code that, when executed by a processor, causes the product to: receive, at a sound mapping system, an indication to output a sound at one of a plurality of audio output devices; determine, utilizing the sound mapping system, at least one audio output device of the plurality of audio output device to output the sound, wherein the determining comprises identifying a component corresponding to the sound and associating the component with the at least one audio output device; and output, utilizing the sound mapping system, the sound from the at least one audio output device.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for outputting a sound from at least one audio output device associated with a component a sound mapping system.

FIG. 4 illustrates an example multi-monitor setup containing a plurality of audio output devices.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

A conventional computer workstation will include standard components, for example, a processing unit, a monitor, peripheral devices (e.g., keyboard, mouse, speaker, camera, etc.), and/or the like. A monitor is included to display whatever information is being provided by the processing unit. Additionally, some monitors, particularly monitors as originally designed, include a speaker built into the monitor. Then, when utilizing a monitor in a conventional workstation, any sound that may accompany information being displayed on the monitor will then be outputted by the speaker integrally coupled to the monitor for a user to hear.

As technology surrounding a workstation has advanced, the inclusion of a speaker integrally coupled to a monitor has disappeared. Now, it is common to have to purchase a monitor for displaying information and separately purchase a speaker for the workstation. A standalone speaker can still be connected to a monitor in order to relay sound information associated with displayed information; however, a standalone speaker may also be inputted directly into a processing unit of a workstation. Connection of a standalone speaker to a processing unit can introduce sound issues and/or lack the ability to provide sound information in support of information displayed on a monitor of the system. Additionally, and/or alternatively, connection of a standalone speaker to the system includes having to route a speaker to be associated with a monitor of a workstation through settings of the processing unit. In some modern workstation systems, software controls can assist with routing sound outputs associated with information displayed on a monitor to a connected speaker. These software controls include toggling an output switch to then permit the outputting of sound. Additionally, and/or alternatively, software controls may include assigning a speaker to a monitor through a settings menu, that may then require sound adjustments to the software each time that a user desires hearing the sound output associated with information being displayed on a monitor of the workstation. Manually routing the speaker connections to a monitor can be tedious and time consuming.

Modern workstations that include more than one monitor face additional sound output challenges. For example, a system that includes two monitors and only one speaker may result in an overlapping of sound outputs from each monitor. This can provide strain on both the speaker system and a user's ears. Additionally, and/or alternatively, a modern workstation that includes multiple monitors and multiple speakers may be routed to work together, therefore, sound output associated with information being displayed on a monitor may be pushed through all the speakers present at a workstation, for example, a multi-monitor workstation that includes three separate speaker systems will all output the same sounds associated with the information displayed on one monitor present in a multi-monitor workstation. Therefore, what is needed is a system and a method that may dynamically map media present on a monitor in a multi-monitor system to a coupled speaker. In such a system, monitor-specific speaker devices may negate an overlapping of sounds being outputted while removing strain on a speaker and the user listening to the output.

Accordingly, the described system and method provides a technique for outputting sound from at least one audio output device coupled to a monitor by use of a sound mapping system. A multi-monitor system, and/or workstation setup, may include two or monitors that may display information from a single computer, and/or processing unit. While the multi-monitoring system is in use, the system may receive an indication at an application present on a monitor to output sound. An indication describes any triggering event that may warrant sound output to be provided to a user, for example, a notification chime from an active application, the playing of a video that includes sound, the selection of a track from a streaming application, and/or the like. Upon receiving the indication, the multi-monitor system utilizing a sound mapping system may determine at least one audio output device to output the sound. The sound mapping system may track a location of an application on a monitor present within the multi-monitor setup, and based upon the location of the application (e.g., a graphical user interface (GUI) thereof rendered to a monitor, etc.), and even more specifically the monitor containing the application, the sound mapping system may route the sound to the correct audio output device(s) coupled to the monitor.

Rather than all sound outputs being directed to one and/or all connected speakers in a system, the system and method described herein may route the sound output media associated with an application being displayed on a monitor to the correct audio output device(s) coupled to the monitor. This is an improvement over traditional systems that lack an ability to map outputs, particularly in a multi-stream system, to at least one speaker that is coupled to the monitor displaying and/or containing a media source. Such a system and method may clearly output sound associated with a present application, and/or media source, and may further decrease damage to components of a speaker system.

The illustrated example embodiments will be best understood by reference to the figures. The following description is intended only by way of example, and simply illustrates certain example embodiments.

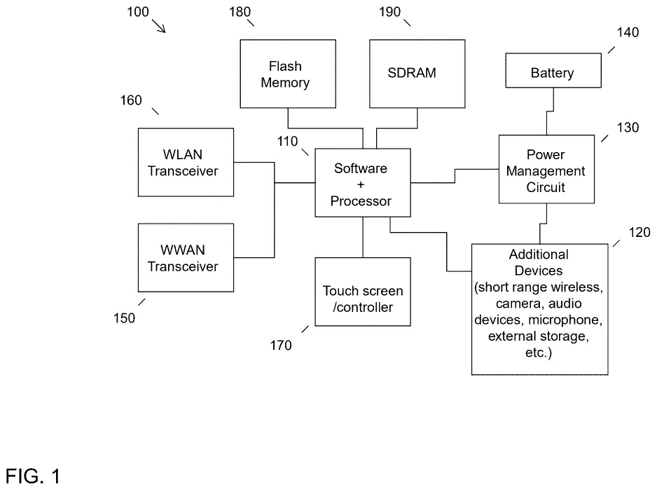

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and synchronous dynamic random-access memory (SDRAM) 190.

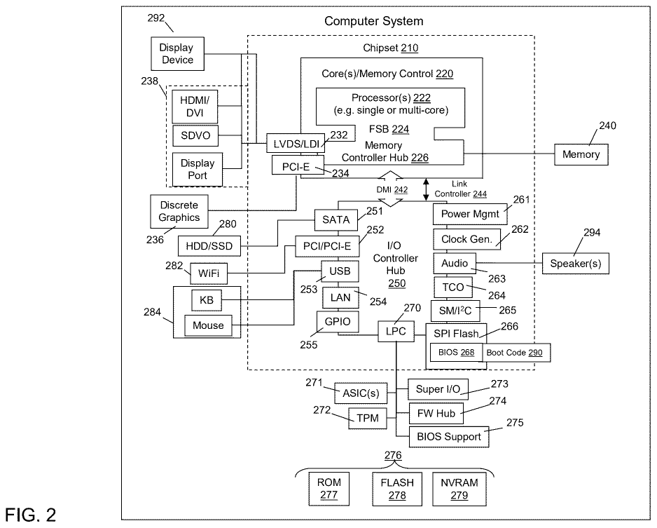

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be used in devices or systems associated with servers and networks to which servers may be added or provisioned and devices or systems that may assist in outputting sound from at least one audio output device associated with a component of a multi-monitor system. For example, the circuitry outlined in FIG. 1 may be implemented in a tablet or smart phone embodiment, whereas the circuitry outlined in FIG. 2 may be implemented in a personal computer embodiment.

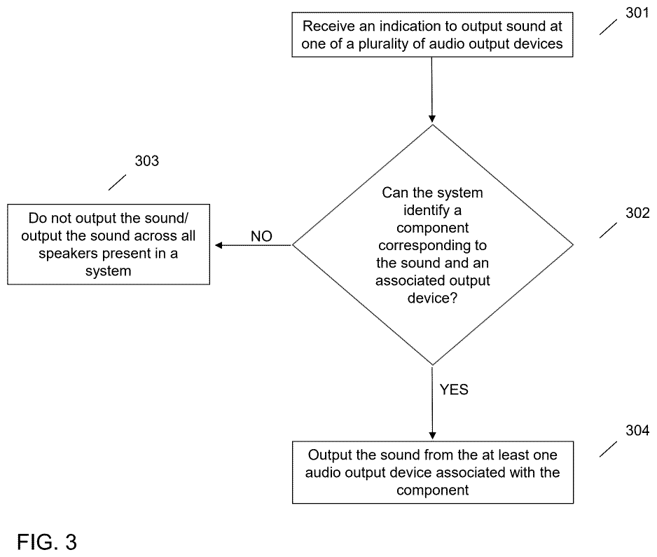

FIG. 3 illustrates a method for outputting a sound from at least one speaker coupled to a monitor by use of a sound mapping system. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to output sound from at least one audio output device coupled to a monitor in a multi-monitor system. For ease of readability, a speaker will be the example audio output device utilized. However, this is not intended to limit this disclosure to only speakers, as any audio output device can be utilized. Additionally, the sound mapping system sound mapping system includes modules and features that are unique to the described system.

The activation of the sound mapping system may be manual, where a user provides an input indicating that the sound mapping system should be activated, or automatic where the sound mapping system detects a trigger event indicating that the system should be activated. Example trigger events include detection of an indication received by an application majorly positioned on a monitor of a multi-monitor system (e.g., a notification chime associated with the application), an input provided by a user to activate an application and/or an application component (e.g., selecting “Play” for a piece of media on a streaming platform, etc.), and/or the like. For example, the system may identify that a user is providing an input at a streaming platform application present on an information handling device that may be considered a trigger event that activates the sound mapping system. As another example, the activation of an application present on an information handling device may be identified as a trigger event.

The sound mapping system may be a standalone system, may be accessible through other computing devices, and/or a combination thereof. For example, the sound mapping system may be a standalone system that can be accessed by a user and/or may be or provide an application that is accessible by a user on another computing device. The sound mapping system may be accessible using any type of computing device, for example, personal computer, laptop computer, smartphone, tablet, smartwatch, head-mounted display, smart television or other smart appliance, augmented reality device, virtual reality device, and/or the like. Thus, the sound mapping system may be accessible locally using a computing device where the sound mapping system is installed and/or may be accessible remotely through another computing device. For example, the sound mapping system may be accessed by a system who has received an indication at an application of an information handling device present on a monitor of a multi-monitor system. However, the sound mapping system may be located and operate on a different information handling device to perform the described steps.

The sound mapping system may have an associated graphical user interface (GUI). The graphical user interface may be provided on a display or monitor, which may or may not be associated with the sound mapping system. In other words, the sound mapping system may have a dedicated display or monitor or may be accessible using any display or monitor. In either case, the sound mapping system may provide instructions to generate and display the graphical user interface on the display device being used to access the sound mapping system. The graphical user interface may also be updated and managed based upon instructions provided by the sound mapping system. In other words, the sound mapping system generates and transmits instructions to create and update the graphical user interface.

The graphical user interface may include a plurality of tabs, windows, and/or unique interfaces. The graphical user interface may include graphical user interface icons or elements. Graphical user interface icons or elements may include static non-selectable elements (e.g., headers, footers, logos, global information areas, graphics, etc.), dynamic non-selectable elements (e.g., local information areas applying to a specific element, dynamic graphics, information areas that update based upon the information provided therein, indicators, statistics displays, etc.), static selectable elements (e.g., radio buttons, menu icons, selectable indicators, etc.), dynamic selectable elements (e.g., form field input areas, pull-down menus, pop-up windows, etc.), and/or any other elements that may be found in a graphical user interface.

The graphical user interface may allow a user to provide input identifying information to be used by the sound mapping system. For example, the sound mapping system may utilize an outlined relationships established between at least one speaker and a monitor present in a multi-monitor system setup. The graphical user interface may allow for a user to alter the relationship between at least one audio output device and a monitor by adjusting an output source, removing an output source, and/or the like. The graphical user interface may also allow a user to review relationships between at least one speaker and a monitor and further adjust when sound should be output from the associated speaker present in the multi-monitor system. The user may also provide information or notes in relation to an alert or notification through the graphical user interface.

Within the graphical user interface, the user may also identify, select, remove, and/or otherwise modify devices that may be utilized to output sound from at least one speaker coupled to a monitor. The user may also access information related to these devices, for example, information identifying device identifiers, device components or sensors, the location of the devices, and/or the like. Additionally, the graphical user interface may allow a user to access the relationships between at least one speaker and monitor present in a multi-monitor system and adjust the mapping of sound output to an additional and/or alternative source. Input may be provided by the user using any type of input modality, including, but not limited to, mechanical input (e.g., keyboard input, mouse input, etc.), touch input, audible or voice input, gesture input, haptic input, input from an augmented reality or virtual reality device, and/or the like.

It should be noted that the information to be used by the sound mapping system and information provided by the sound mapping system can be different for different applications, different computing systems, different users, and/or the like. Thus, the information corresponding to input or output of the sound mapping system are not always the same. However, the sound mapping system may have default or system-wide settings that are the same across different users, systems, applications, and/or the like, until the information is adjusted or otherwise changed.

It should be noted that different users may configure the graphical user interface per their preferences. Thus, the graphical user interface layout and configuration may be different between users. How much a user can configure the layout may be restricted or set by a system administrator and/or the like. Additionally, different users or different user roles may have different levels of access, which may also change how and what information is displayed. Thus, different graphical user interfaces may be displayed by the system. As an example, an override may be provided upon operative coupling of a wired headset (e.g., earpiece, earpieces, headphones, etc.) and/or a wireless headset (e.g., earbud, earbuds, headphones, etc.). In a work environment, speaker volume may be administratively restricted while in-ear or over-the-ear devices may be unrestricted, noting that in some situations, in-ear or over-the-ear devices may be prohibited administratively.

The sound mapping system may utilize one or more artificial intelligence models in performing the receipt of an indication at an application present on a monitor to output sound in a multi-monitor system, determine at least one audio output device to output sound, and output the sound from at least one speaker coupled to a monitor present in a multi-monitor system. Artificial intelligence models may also be used for steps within a step. For example, a model can be used to determine the most appropriate speaker present in a multi-monitor system containing a plurality of speakers based upon user attention, and/or the like. For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model that is fine-tuned for the sound mapping system or may be a model that is created from scratch. Since the sound mapping system is used in conjunction with identification of relationships between at least one speaker and a monitor present in a multi-monitor system, artificial intelligence techniques for determining a direction of user attention, and/or the like, some models that may be utilized by the system are image analysis models, entity identification models, similarity identification models, analysis models, filtering models, classification models, and/or the like. The model may be trained using one or more training datasets. Additionally, as the model is deployed, it may receive feedback to become more accurate over time. The feedback may be automatically ingested by the model as it is deployed, and thereafter, the model may ingest this feedback to refine the model. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, and/or the like.

As previously mentioned, an ensemble of models or multiple models may also be utilized. Some example models that may be utilized are variational autoencoders, generative adversarial networks, recurrent neural network, convolutional neural network, deep neural network, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model.

The sound mapping system may include different components for carrying out different functions of the system, including different steps to be performed. These components may be hardware components or software components. Some hardware components may include image capture sensors to capture information a user's attention why utilizing a multi-monitor system. This is in contrast to traditional sound mapping between at least one speaker and monitor present in a system. Traditional sound mapping is unable to identify a direction of a user's attention. However, in order to perform the sound mapping to a correct output source, the sound mapping system needs to capture both image data of a user and weigh this data against predetermined relationships between at least one speaker coupled to a system and the associated monitor present in a multi-monitor system. There are many different devices or systems that can be utilized that can capture either image data. Some example systems or devices that may be utilized include, but are not limited to, surveillance cameras, smart phones, augmented reality devices, virtual reality devices, three-dimensional cameras, and/or the like. Performing the sound mapping may be assisted utilizing one or more artificial intelligence models.

Artificial intelligence models can be used when directing sound to an audio output device and/or speaker based upon a relationship between at least one speaker and a monitor present in a multi-monitor system. Artificial intelligence models can also be used in the capturing of the user behavior while a multi-monitor system is in use. Additionally, models can be used in performing any verification of information contained within a list or predetermined relationships between components present in a multi-monitor system setup. Additionally, or alternatively, the artificial intelligence models can be used to perform other steps, assist in performing some of the steps, and/or the like.

At 301, the system may receive an indication at an application present on a monitor to output sound at one of a plurality of audio output devices coupled to the system. A multi-monitor system includes at least two monitors operatively coupled together. The at least two monitors of the multi-monitor system may act as an extension of a single display across them. Additionally, and/or alternatively, the at least two monitors of the multi-monitor system may operate independently of one another. A monitor in the multi-monitor system may display an application stored within a computer, and/or processing unit. The application may include visual media and/or audio media, for example, music, speech (e.g., lecturer data, audio book data, translation data, etc.), notifications, and/or the like, that in response to receiving an indication at an application 301, an audio output device associated with the system may output a sound for the user to hear. As mentioned previously, for ease of readability, a speaker will be the example audio output device utilized. However, this is not intended to limit this disclosure to only speakers, as any audio output device can be utilized.

An application present on a monitor may be positioned in a way that establishes a location of the application on one monitor over an alternate monitor present in the multi-monitor system setup. When an entirety of an application is contained within a single monitor, and/or displayed on a single monitor, then the position, and/or location, of the application is on said monitor. Additionally, when an application is positioned to extend, and/or spill over, onto an alternate monitor, the monitor that contains more than half of the area in which the application consumes is considered the contain the application; therefore, the position of the application falls under the monitor displaying the majority of the application. Additionally, and/or alternatively, when an application is positioned to extend onto an alternate monitor and exactly half of the application is present on two separate monitors present in the multi-monitor system setup, the monitor that previously contained the majority of the application is considered to include the position of the application. Additionally, when an application has been minimized to no longer be displayed on a monitor, the position of the application is contained within the monitor that most recently displayed the majority of the application prior to minimization. Throughout the remainder of this application reference to an entire application contained within a monitor establishing a position of the application may be made. However, this is intended as a non-limiting example. A position, and/or location, of an application on a monitor may be established under any of the circumstances mentioned previously.

An indication at an application present on a monitor to output a sound 301 may including receiving a notification at an application being displayed on the monitor. For example, in the system, an email application (e.g., Microsoft Outlook, Gmail, Yahoo!, etc.) may receive a new email which is traditionally accompanied by a notification chime. A notification chime is the received indication 301. Additionally, and/or alternatively, an indication at an application may be an input provided by a user to activate an application. For example, an input provided by a user to activate an application includes the selection of an application that contains a sound upon opening (e.g., a videogame welcome screen, etc.), a selection of a music track in a streaming application (e.g., AppleMusic, Spotify, etc.), a selection of a video on a video streaming platform (e.g., YouTube, Netflix, Hulu, etc.), and/or the like. Additionally, and/or alternatively, receiving an indication at an application present on a monitor may include the selecting of media instruction, for example, pausing, playing, fast-forwarding, rewinding, and/or the like. No matter the indication received at an application on a monitor 301, the multi-monitor system setup in use may identify the application influencing, and/or being influenced by, the indication and the position of said application on a monitor. In other words, the receiving the indication 301 may be tracked by the system to identify where an application is located in a multi-monitor system setup.

A multi-monitor system setup may include two or more monitors coupled to one computer and/or processing unit. Additionally, the multi-monitor system setup may include at least one speaker for outputting sound. Though only one speaker is required for a system, even for a system that it performing multi-stream mixing, for an ease of understanding, reference to a multi-speaker setup and/or two or more speakers may be referenced herein. This is intended as a non-limiting example, for the description of mapping monitors that will be described further can be performed with a single speaker. Each monitor present in a multi-monitor system setup may be mapped to a single audio output device. Additionally, and/or alternatively, each monitor present in a multi-monitor system setup may be mapped to an individual speaker, where the individual speaker is specific to the monitor. Additionally, and/or alternatively, one or more monitors of the multi-monitor system setup may be mapped to a combination of available speakers coupled to the system. The sound mapping system of an information handling device may track a relationship between each monitor present in a multi-monitor system setup and their associated at least one speaker.

After receiving an indication at an application present on a monitor to output sound 301, a sound mapping system of the information handling device may attempt to identify if a component corresponding to the sound and associated with an audio output device 302 is present. In other words, the sound mapping system may determine if at least one speaker to output the sound is coupled to the monitor that received the indication 301. The sound mapping system may identify which speaker(s) are associated with each monitor present in the multi-monitor system. This identifying of a speaker associated with a monitor stems from the component corresponding to the sound 302, further instructing, by use of the sound mapping system, where a sound may be output from in relation to the location of information on a specified monitor. If it is determined that a monitor of a multi-monitor system setup is not coupled to a speaker, and/or lacks a component corresponding to the sound, the sound mapping system may not output the sound 303 associated with an application that received the indication. A component corresponding to the sound may include meta data describing how a sound may be output to a user. Meta data may include, but is not limited to, a sound-type (e.g., chime, song, lecture, etc.), a required audio output device-type (e.g., traditional device speaker, a sound-specific speaker, headphones, etc.), and/or the like. Additionally, and/or alternatively, when it is determined 302 that a monitor of the multi-monitor system setup is not coupled to at least one speaker 303, and/or is coupled to a system using a traditional method, the system may output a sound across all speakers present in the system. As mentioned previously, a traditional method for outputting sound at a system includes outputting sound across a standard speaker, and/or across all speakers, coupled to a system.

Alternatively, in the system and in response to receiving an indication at an application present on a monitor to output sound 301, a sound mapping system of an information handling device may identify a component corresponding to the sound and associated output device 302. The sound mapping system may determine that at least one speaker is mapped and coupled to a monitor that includes the application. A relationship between a monitor and a speaker is predetermined. For example, if a multi-monitor system setup includes two monitors and two speakers, a relationship establishing that one speaker is coupled to one monitor and the other speaker is coupled to the other monitor is predetermined prior to receiving an indication 301. A predetermined relationship between a monitor of the multi-monitor system and a speaker coupled to the multi-monitor system establishes where an output of sound associated with a position of an application on a monitor will be provided from 304. Additionally, a predetermined relationship describes all components corresponding to a sound and their associated output device. Therefore, when a component of a sound (e.g., sound-type, information displayed on a monitor, etc.) is identified, the sound mapping system may determine a correct output device to supply sound to a user.

In the system, a relationship between a monitor and a speaker present in the multi-monitor system setup may output the sound associated with the application being displayed on the monitor 304. Therefore, when at least one speaker coupled to a monitor is outputting a sound 304 based on the position of an application on the monitor, and a user elects to reposition (e.g., drag, reopen, etc.) the application on a different monitor than the one previously containing the application, the output of the sound may move from one speaker to another speaker. This is because of the relationship established between at least one speaker and a monitor in the multi-monitor system setup. Additionally, and/or alternatively, a speaker that is coupled to two monitors present in a multi-monitor system setup and an application displayed on one of said monitors receives an indication to output sound data from the coupled speaker 301, the sound mapping system may map the output sound 304 to said speaker. Then, upon the repositioning of the application from a first monitor coupled the speaker to a second monitor coupled to the same speaker, the output sound may remain being output from the same speaker without interruption. Therefore, in the system, a speaker may be coupled to one or more monitors present in a multi-monitor system setup.

Additionally, and/or alternatively, the sound mapping system of an information handling device may utilize one or more sensors operatively coupled to the information handling device to determine a user position in the multi-monitor system setup to dynamically direct sound output for the user to hear. In the system, one or more sensors operatively coupled to the system may continuously track a user position while a multi-monitor system is in use. The one or more sensors include, but are not limited to, for example, image capturing devices, audio capturing devices, infrared devices, and/or the like. In the system, a sensor may utilize one or more user attention-determining techniques, for example, gaze detection data collected from one or more image capturing devices, to determine where a user is looking upon the providing of an indication 301. Then, in this system, the sound mapping system may identify a component corresponding to a sound and an associated output device 302 to determine the monitor in which a user's attention is directed towards, and may thereafter output sound 304 through at least one speaker coupled to the monitor that a user is viewing.

The sound mapping system of the information handling device may then continue to output the sound 304 at the coupled speaker to the device that a user is viewing until the completion of outputting the sound. Being that a user's attention was determined to be directed to a monitor, the application opened, and/or the received indication for outputting sound, may remain in a position at the monitor a user previously viewed, even subsequent to a user's attention being directed to a different monitor of the multi-monitor system setup. Additionally, and/or alternatively, as the output of sound 304 is continuing and the user's attention moves from one monitor to another in the multi-monitor system setup, the position of the application on the monitor may move from one monitor to the another monitor, and therefore, the output sound may move from at least one speaker previously outputting the sound to a new speaker associated with the monitor currently being viewed by the user. An artificial intelligence model may be employed by the sound mapping system of an information handling device and used in combination with the attention-determining techniques of the sound mapping system to assist with accurately tracking user attention and the monitor a user is currently viewing in a multi-monitor system.

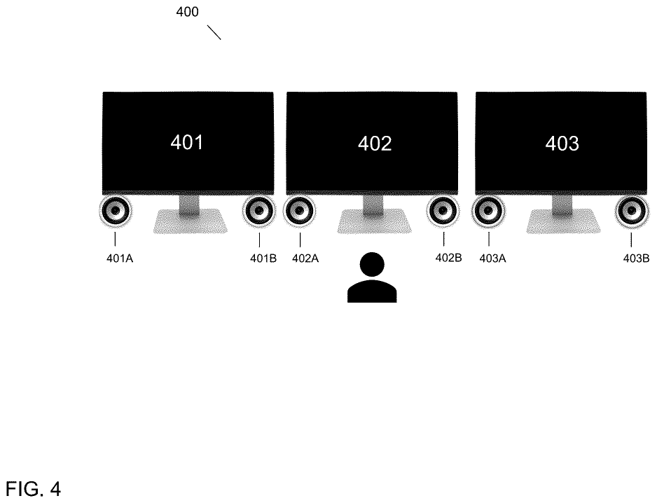

Referring now to FIG. 4, an illustrated an example multi-monitor setup containing a plurality of speakers is provided. A multi-monitor system setup 400 is presented comprising three monitors 401, 402, and 403, and six speakers 401A, 401B, 402A, 402B, 403A, and 403B. The multi-monitor system setups described herein are intended as non-limiting. Relationships between monitors and speakers may go beyond what is presented in the following examples, and may further utilize an artificial intelligence model of the sound mapping system to influence how a sound may be outputted at a system to a user.

In a system, for example, a relationship between each monitor and the outline speakers may be established. The sound mapping system may determine that speakers 401A and 401B are coupled to monitor 401, the speakers 402A and 402B are coupled to monitor 402, and the speakers 403A and 403B are coupled to monitor 403. Then, upon receipt of an indication at an application to provide an output sound, the sound mapping system may determine a position of an application on a monitor in the multi-monitor system. In this example, the sound mapping system may determine that the application is present on monitor 401. Upon receiving an indication to output sound while an application is present on monitor 401, the sound may be outputted from speaker 401A and speaker 401B only. The predetermined relationship between speaker 401A and speaker 401B and monitor 401 ascertains that an indication received at an application positioned on monitor 401 will output the sound at speakers 401A and 401B.

Then, as output sound is still being supplied from speakers 401A and 401B, a user may elect to drag the application from monitor 401 to monitor 402. Once the majority of the application window moves from monitor 401 to monitor 402, the output sound being supplied from speakers 401A and 401B now transitions to speakers 402A and 402B. This transition of sound output between speakers occurs because the position of the application moved from monitor 401 to monitor 402, and therefore, the speakers associated with monitor 402 (speakers 402A and 402B) may now output the sound associated with the monitor 402. Further, if an application requesting outputting sound transitions to monitor 403 from monitor 402, the speakers 403A and 403B will takeover outputting the sound to the user.

Additionally, in a system, for example, a relationship between monitor 401 and speaker 402A is established, a relationship between monitor 402 and speakers 402A and 402B is established, and a relationship between monitor 403 and speaker 402B is established. An application present on monitor 402 may receive an indication to output sound, and thus, sound may be outputted from both speakers 402A and 402B. Then, a user may elect to drag the application window from monitor 402 over to monitor 403. The sound mapping system may identify this transition from monitor 402 to monitor 403 and adjust the sound output from both 402A and 402B to only 402B because, as mentioned previously, monitor 403 has a predetermined relationship with speaker 402B. As the application is positioned on monitor 403, any output sound associated with the application may be supplied from speaker 402B only. Similarly, if a user elects to reposition an application that received an indication to output sound from monitor 403 to monitor 401, speaker 402B may stop outputting sound and speaker 402A that has an established relationship with monitor 401 may continue outputting the sound associated with the application that is now positioned at monitor 401.

Additionally, in a system, for example, a relationship between monitor 401 and speakers 401A and 401B is established, a relationship between monitor 402 and speakers 401B and 403A is established, and relationship between monitor 403 and speakers 403A and 403B is established. An application window that receives an indication to output sound and is positioned on monitor 401 may then output sound through speakers 401A and 401B. Then, as the application window is repositioned to be contained within monitor 402, speakers 401B and 403A may output the sound associated with the application. Speaker 401B maintains outputting sound when the application is positioned in both monitor 401 and monitor 402 because a relationship between the speaker 401B and monitors 401 and 402 are previously established. Similarly, as a user repositions an application from monitor 402 to monitor 403, speaker 403A will continue to output sound and speaker 403B which also has a relationship with monitor 403 may then become active and output the sound associated with the application.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
receiving, at a sound mapping system, an indication to output a sound at one of a plurality of audio output devices;
determining, utilizing the sound mapping system, at least one audio output device of the plurality of audio output devices to output the sound, wherein the determining comprises identifying a component corresponding to the sound and associating the component with the at least one audio output device; and
outputting, utilizing the sound mapping system, the sound from the at least one audio output device.

2. The method of claim 1, wherein the determining comprises identifying the sound is associated with an application present on a display having a corresponding audio output device.

3. The method of claim 1, wherein each of more than one of the plurality of audio output devices corresponds to one of a plurality of monitors.

4. The method of claim 3, wherein the component comprises one of the plurality of monitors, and wherein the determining comprises identifying that the monitor is displaying an application corresponding to the sound.

5. The method of claim 1, wherein the determining comprises detecting a location of a gaze of the user upon receipt of the indication and correlating the location of the gaze to the component.

6. The method of claim 1, wherein the determining comprises accessing meta data associated with the sound and identifying, based upon the meta data, the component.

7. The method of claim 1, wherein the determining comprises identifying a location of each of the plurality of audio output devices with respect to a location of a user receiving the sound output.

8. The method of claim 1, wherein the determining comprises identifying preferences of a user with respect to sound outputs and identifying the component based upon the preferences.

9. The method of claim 1, wherein the outputting comprises routing the sound to the at least one audio output device.

10. The method of claim 1, wherein the determining comprises utilizing the sound mapping system to identify a relationship between the at least one audio output device and the component.

11. A device, the device comprising:
a processor;
a memory device that stores instructions that, when executed by the processor, causes the device to:
receive, at a sound mapping system, an indication to output a sound at one of a plurality of audio output devices;
determine, utilizing the sound mapping system, at least one audio output device of the plurality of audio output devices to output the sound, wherein the determining comprises identifying a component corresponding to the sound and associating the component with the at least one audio output device; and
output, utilizing the sound mapping system, the sound from the at least one audio output device.

12. The device of claim 11, wherein the determining comprises identifying the sound is associated with an application present on a display having a corresponding audio output device.

13. The device of claim 11, wherein each of more than one of the plurality of audio output devices corresponds to one of a plurality of monitors.

14. The device of claim 13, wherein the component comprises one of the plurality of monitors, and wherein the determining comprises identifying that the monitor is displaying an application corresponding to the sound.

15. The device of claim 11, wherein the determining comprises detecting a location of a gaze of the user upon receipt of the indication and correlating the location of the gaze to the component.

16. The device of claim 11, wherein the determining comprises accessing meta data associated with the sound and identifying, based upon the meta data, the component.

17. The device of claim 11, wherein the determining comprises identifying a location of each of the plurality of audio output devices with respect to a location of a user receiving the sound output.

18. The device of claim 11, wherein the determining comprises identifying preferences of a user with respect to sound outputs and identifying the component based upon the preferences.

19. The device of claim 11, wherein the outputting comprises routing the sound to the at least one audio output device.

20. A product, the product comprising:
a computer-readable storage device that stores code that, when executed by a processor, causes the product to:
receive, at a sound mapping system, an indication to output a sound at one of a plurality of audio output devices;
determine, utilizing the sound mapping system, at least one audio output device of the plurality of audio output devices to output the sound, wherein the determining comprises identifying a component corresponding to the sound and associating the component with the at least one audio output device; and
output, utilizing the sound mapping system, the sound from the at least one audio output device.
